(19) United States
(12) Patent Application Publication
(10) Pub. No.: US 2012/0048488 A1
(43) Pub. Date: Mar. 1, 2012

(54) WINDOW BLIND ASSEMBLY FOR VEHICLE

(75) Inventors: Won Suk Oh, Seoul (KR); Ki Kyung Bae, Anseong-si (KR); Ki Hong Kim, Anseong-si (KR); Jeong Soon Park, Ansan-si (KR); Bong Jung Kim, Anseong-si (KR); Kyoo Kang Shim, Pyeongtaek-si (KR)

(73) Assignee: KOREA FUEL-TECH CORPORATION

(21) Appl. No.: 13/215,578

(22) Filed: Aug. 23, 2011

(30) Foreign Application Priority Data
Aug. 26, 2010 (KR) 10-2010-0082975
Aug. 26, 2010 (KR) 10-2010-0082981

(51) Int. Cl. B60J 3/02

(52) U.S. Cl. 160/370.22

(57) ABSTRACT

There is a need for a window blind assembly for a vehicle, in which vibration and noise are reduced when a shade curtain moves. The window blind assembly for a vehicle includes: a main frame; a rotary shaft rotatably arranged in the main frame; a pair of guide rails arranged in the main frame and formed with a guide groove; a shade curtain supporter movably coupled to the pair of guide rails; a shade curtain including one side end portion connected to the rotary shaft and rolled into the rotary shaft, and the other side end portion connected to the shade curtain supporter and unrolled as the shade curtain supporter becomes apart from the rotary shaft; and a driving unit providing driving force to move the shade curtain supporter along the guide rail, the driving unit including: a motor; a gear assembly connected to the motor; and a first wire having a closed-loop shape and connected to the gear assembly so that driving force of the motor can be transferred to the shade curtain supporter.

### CROSS-REFERENCE TO RELATED APPLICATIONS

This application claims the benefit of priorities of Korean Patent Application No. 10-2010-0082975 filed on Aug. 26, 2010 and Korean Patent Application No. 10-2010-0082981 filed on Aug. 26, 2010, all of which are incorporated by reference in their entirety herein.

### BACKGROUND OF THE INVENTION

1. Field of the Invention

The present invention relates to a window blind assembly for a vehicle, and more particularly to a window blind assembly for a vehicle, which is arranged on a window of a car and blocks light from coming through the window.

2. Related Art

In a car, the recent trend is to provide a relatively large-sized window taking design or the like into account. The car having such a large-sized window has merits in satisfying a car buyer with beauty.

However, strong sunlight may penetrate the large-sized window provided for emphasizing the beautiful design of the car, and heat due to the penetrated strong sunlight may be accumulated inside the car and offend a passenger in the car.

To prevent the heat from being accumulated inside the car due to sunlight transmitted through the large-sized window, too much load is applied to an air conditioner, thereby causing eneryy loss to increase. Also, the large-sized window laying emphasis on the beautiful design is disadvantageously vulnerable to protect privacy of a passenger in the car. Thus, a window blind has been developed for covering the window of the car so as to block the light penetrated into the car through the window and protect the passenger's privacy. However, a conventional window blind for a car has a problem of causing vibration and noise when a shade curtain reciprocates.

### SUMMARY OF THE INVENTION

Accordingly, the present invention is conceived to solve the forgoing problems, and an aspect of the present invention is to provide a window blind assembly for a vehicle, in which vibration and noise are reduced when a shade curtain moves.

Technical aspects of the present invention are not limited to the foregoing technical aspect, and other technical aspects not mentioned above will be clearly understood by those skilled in the art from the following descriptions.

The foregoing aspects may be achieved by providing a window blind assembly for a vehicle includes: a main frame; a rotary shaft rotatably arranged in the main frame; a pair of guide rails arranged in the main frame and formed with a guide groove; a shade curtain supporter movably coupled to the pair of guide rails; a shade curtain including one side end portion connected to the rotary shaft and rolled into the rotary shaft, and the other side end portion connected to the shade curtain supporter and unrolled as the shade curtain supporter becomes apart from the rotary shaft; and a driving unit providing driving force to move the shade curtain supporter along the guide rail, the driving unit including: a motor; a gear assembly connected to the motor; and a first wire having a closed-loop shape and connected to the gear assembly so that driving force of the motor can be transferred to the shade curtain supporter.

The first wire may be provided as a pair to respectively transfer driving force to opposite end portions of the shade curtain supporter.

The gear assembly may include a wire driving wheel to transfer rotary force from the motor to the pair of first wires, and the pair of first wires may be connected to the wire driving wheel so that the pair of first wires can rotate in opposite directions to each other.

The wire driving wheel may be provided as a single, and the wire driving wheel may be formed with grooves on an outer circumference thereof for the pair of first wires to be respectively arranged on the wire driving wheel.

The gear assembly may include a first gear connected to a motor shaft of the motor, the motor shaft may be provided as a worm shaft to change a rotary axis for rotary force from the motor, and the first gear may be provided as a worm gear.

The driving unit may further include a support wheel unit, and the first wire may include one side end portion connected to the gear assembly, and the other side end portion rotatably supported by the support wheel unit.

The shade curtain supporter may include a support body connected to the one side end portion of the shade curtain, and a connection unit formed at opposite end portions of the support body, and the connection unit may be fastened to the first wire so that the support body can move as the first wire rotates.

The support wheel unit may be arranged in the guide rail so as to rotatably support one side end portion of the first wire.

The driving unit may further include a guide wheel unit positioned between the gear assembly and the support wheel unit so as to guide the first wire.

The guide wheel unit may include a wheel base; and a first guide wheel and second guide wheel arranged on the wheel base and rotatable with respect to one shaft, the first and second guide wheels may be rotatable independently of each other, and the first guide wheel may guide a first section of the first wire moving in a first direction, and the second guide wheel may guide a second section of the first wire moving in a direction opposite to the first direction.

The guide wheel unit may further include a wheel casing coupling with the wheel base so as to accommodate the first and second guide wheels therein, and the wheel casing may be formed with a plurality of through holes so that the first wire can pass through the guide wheel unit.

The first wire may form a pair to respectively transfer driving three to opposite end portions of the shade curtain supporter, the gear assembly may include a wire driving wheel to transfer rotary force from the motor to the pair of first wires, and the pair of first wires may be connected to the wire driving wheel so that the pair of first wires can rotate in opposite directions to each other, one of the pair of first wires being connected to the guide wheel unit as being twisted by 180 degrees so as to transfer driving force in one direction to opposite end portions of the shade curtain supporter.

The support wheel unit may be arranged in the main frame, and the driving unit may further include second wire which has one side connected to the support wheel unit so as to transform rotary motion of the support wheel unit into rectilinear motion, and the other side connected to the shade curtain supporter so as to move the shade curtain supporter.

The shade curtain supporter may include a support body connected to the one side end portion of the shade curtain, and a connection unit formed at opposite end portions of the support body, and the connection unit may be fastened to the second wire so that the support body can move as the second wire rectilinearly moves.

The support wheel unit may include a support plate connected to the main frame; a support wheel connected to the first wire and arranged in the support plate so as to be rotated by the first wire; and a support gear arranged in the support plate and rotatable together with the support wheel.

The second wire may include a concavo-convex surface to mate with the support gear so that the second wire can move forward or backward as the support gear rotates.

The support wheel unit may couple with the support plate so as to accommodate the support wheel and the support gear therein, and include a support casing through which the second wire passes, and the support casing may include a plurality of through holes so as to pass the first wire there through.

The first wire may form a pair to respectively transfer driving force to opposite end portions of the shade curtain supporter, the gear assembly may include a wire driving wheel to transfer rotary force from the motor to the pair of first wires, and the pair of first wires may be connected to the wire driving wheel so that the pair of first wires can rotate in opposite directions to each other, one of the pair of first wires being connected to the support wheel unit as being twisted by 180 degrees so as to transfer driving force in one direction to opposite end portions of the shade curtain supporter.

### BRIEF DESCRIPTION OF THE DRAWINGS

FIG. 1 is a perspective view showing an unrolled state of a shade curtain in association with a window blind assembly for a vehicle according to a first exemplary embodiment of the present invention.

FIG. 2 is a perspective view showing a state that the shade curtain is rolled into a rotary shaft in association with the window blind assembly for a vehicle according to the first exemplary embodiment of the present invention.

FIG. 3 is an exploded perspective view of the window blind assembly for a vehicle according to the first exemplary embodiment of the present invention.

FIG. 4 is an exploded perspective view of a guide rail in association with the window blind assembly for a vehicle according to the first exemplary embodiment of the present invention.

FIG. 5 is an exploded perspective view of a driving unit in association with the window blind assembly for a vehicle according to the first and second exemplary embodiments of the present invention.

FIG. 6 is an enlarged perspective view of the driving unit in association with the window blind assembly for a vehicle according to the first and second exemplary embodiments of the present invention.

FIG, 7 is a partial enlarged view of the guide rail in association with the window blind assembly for a vehicle according to the first exemplary embodiments of the present invention.

FIG. 8 is a partial perspective view of a guide wheel in association with the window blind assembly for a vehicle according to the first exemplary embodiments of the present invention.

FIG. 9 is a perspective view showing an unrolled state of a shade curtain in association with a window blind assembly for a vehicle according to the second exemplary embodiment of the present invention.

FIG. 10 is a perspective view showing a state that the shade curtain is rolled into a rotary shaft in association with the window blind assembly for a vehicle according to the second exemplary embodiment of the present invention.

FIG. 11 is an exploded perspective view of the window blind assembly for a vehicle according to the second exemplary embodiment of the present invention.

FIG. 12 is a partial perspective view of a guide rail and a support wheel unit in association with the window blind assembly for a vehicle according to the second exemplary embodiment of the present invention.

FIG. 13 is an enlarged perspective view of the guide rail and the support wheel unit in association with the window blind assembly for a vehicle according to the second exemplary embodiment of the present invention.

FIG. 14 is an enlarged perspective view of the support wheel unit in association with the window blind assembly for a vehicle according to the second exemplary embodiment of the present invention.

### DESCRIPTION OF EXEMPLARY EMBODIMENTS

Hereinafter, exemplary embodiments of the present invention will be described in detail with reference to accompanying drawings. However, the present exemplary embodiments are not limited to the exemplary embodiments disclosed below but may be achieved in various forms. The present exemplary embodiments are provided only for completing the disclosure of the present invention, and let a person having an ordinary skill in the art completely understand the scope of the present invention. Throughout the drawings, shapes or the like of elements may be exaggerated for clearer explanation, and like numerals refer to like elements.

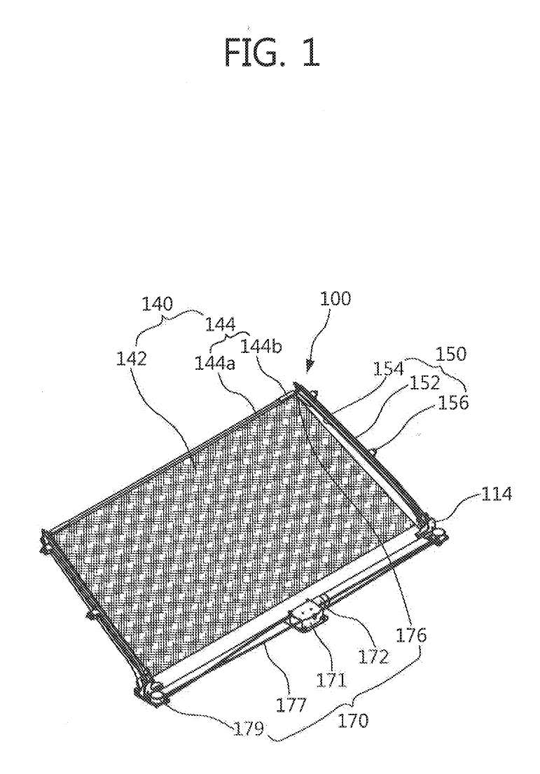

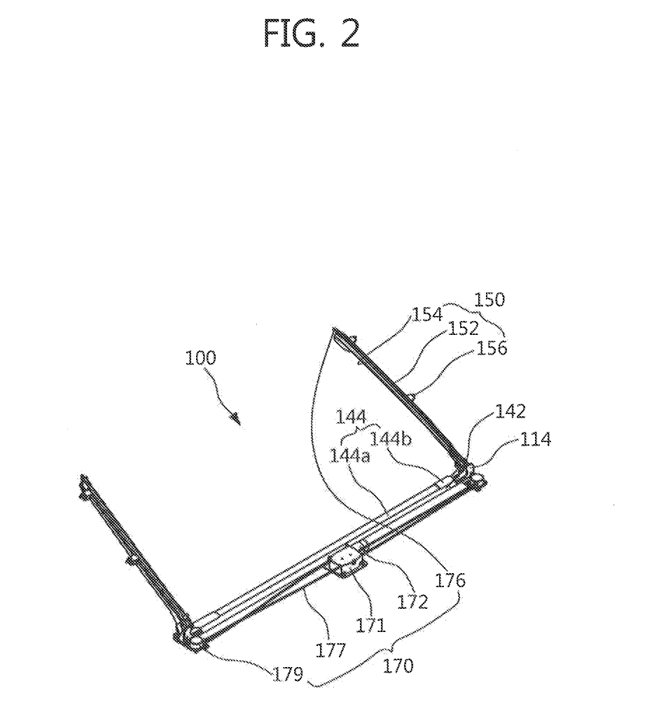

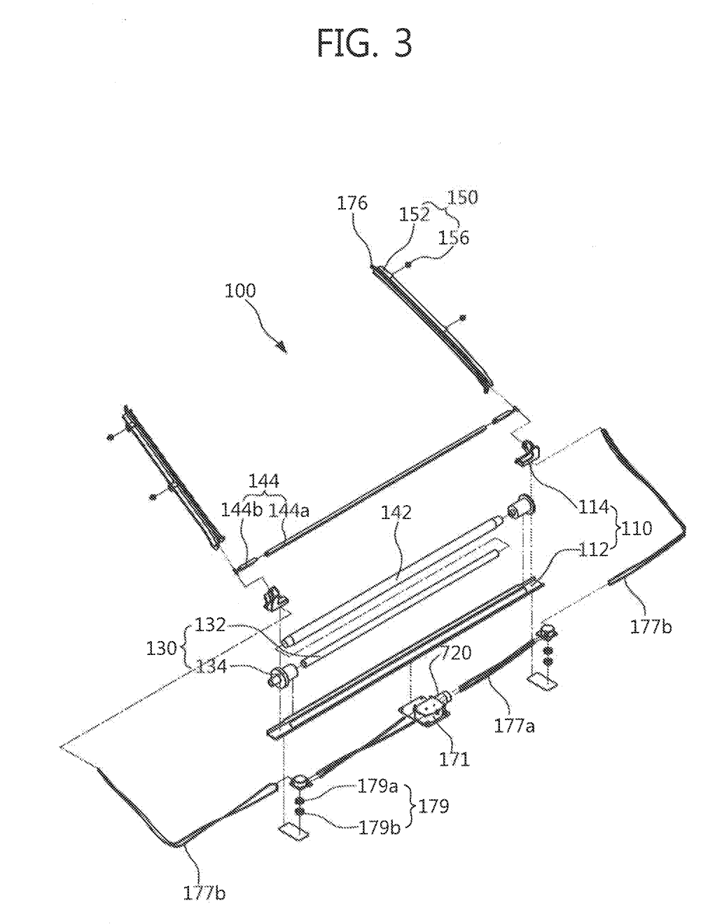

FIG. 1 is a perspective view showing an unrolled state of a shade curtain in association with a window blind assembly for a vehicle according to a first exemplary embodiment of the present invention. FIG. 2 is a perspective view showing a state that the shade curtain is rolled into a rotary shaft in association with the window blind assembly for a vehicle according to the first exemplary embodiment of the present invention. FIG. 3 is an exploded perspective view of the window blind assembly for a vehicle according to the first exemplary embodiment of the present invention. The window blind assembly may be arranged on lateral windows as well as a back window inside the vehicle.

As shown in FIGS. 1 to 3, a window blind assembly 100 for a vehicle according the first exemplary embodiment includes a main frame 110, a shaft unit 130, a blind unit 140, a guide rail 150 and a driving unit 170.

The main frame 110 may be arranged in a boundary region between a back window and a trunk of a vehicle. Also, the main frame 110 may be arranged in parallel with the shaft unit 130 inside the vehicle. The main frame 110 includes a frame bar 112 and a supporter 114. The frame bar 112 may be arranged in the boundary region between the back window and the trunk of the vehicle. The supporters 114 are provided at opposite end portions of the frame bar 120, and supports the shaft unit 130 and the guide rail 150.

The shaft unit 130 includes a rotary shaft 132 and a rotary shaft supporter 134. The rotary shaft 132 may be rotatably coupled to the rotary shaft supporter 134 or the main frame 110. Around the rotary shaft 132 the shade curtain 142 can be wound. The rotary shaft supporter 134 may be arranged in the supporter 114 or frame bar 112 of the main frame 110. The rotary shaft 132 may be internally provided with a spring (not shown) so that the rotary shaft 132 can be pre-stressed in the wind-up direction of winding the shade curtain 142 around the rotary shaft 132 (or in the reverse direction). The spring may have one side fastened to the inside of the rotary shaft 132 and the other side fastened to the rotary shaft supporter 134.

The blind unit 140 includes the shade curtain 142 and a shade curtain supporter 144.

The shade curtain 142 may be a flexible fabric. Alternatively, the shade curtain 142 may be made of various materials which can fully or partially (i.e., semi-transparently) block light or heat. The shade curtain 142 may have one side end portion connected to the shade curtain supporter 144, and the other side end portion connected to the rotary shaft 132 so that the shade curtain 142 can be unrolled as the shade curtain supporter 144 moves up (i.e., as the shade curtain supporter becomes apart from the rotary shaft).

The shade curtain supporter 144 includes a support body 144a and a connection unit 144b.

The support body 144a is connected to one side end portion of the shade curtain 142. Thus, when the support body 144a moves up along the guide rail 150, the shade curtain 142 wound around the rotary shaft 132 can be unrolled.

The connection units 144b may be formed at opposite end portions of the support body 144a. The connection unit 144b may be at least partially accommodated in a guide groove 154 of the guide rail 150. The connection unit 144b is firmly fastened to a wire 177b so that the support body 144a can move up or down along the guide rail 150.

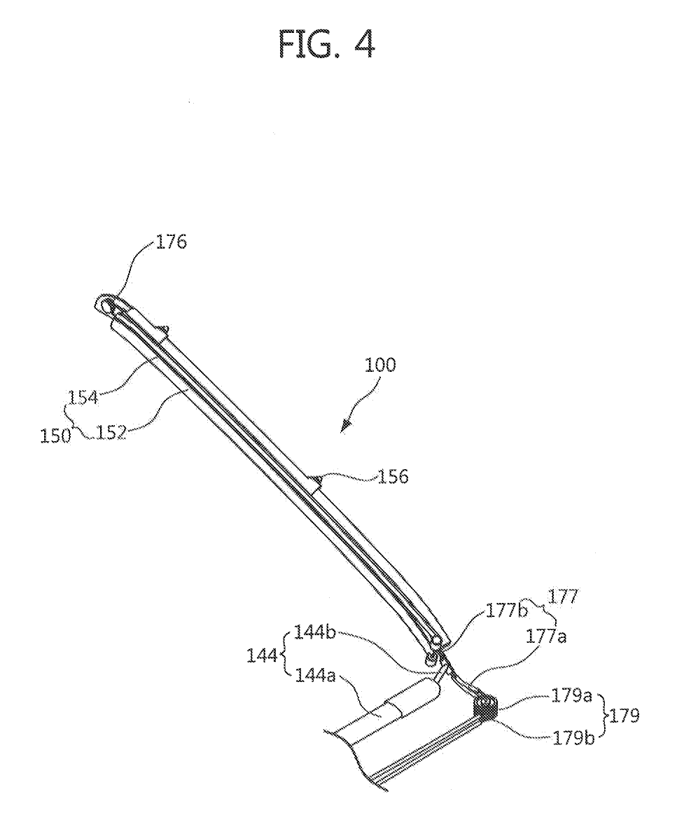

FIG. 4 is an exploded perspective view of a guide rail in association with the window blind assembly for a vehicle according to the first exemplary embodiment of the present invention.

As shown in FIG. 4, the guide rail 150 includes a guide rail body 152, the guide groove 154 and a guide rail supporter 156.

The guide rail body 152 may be arranged in the supporters 114 arranged at opposite end portions of the frame bar 120 (refer to FIG. 3). The guide rail body 152 may be formed with the guide groove 154 so that the connection unit 144b of the shade curtain supporter 144 can he at least partially accommodated in the guide rail body 152. Thus, the shade curtain supporter 144 can move up or down along the guide rail 150.

To fasten the guide rail body 152 to a car chassis, the guide rail body 152 may be formed with a plurality of guide rail supporters 156.

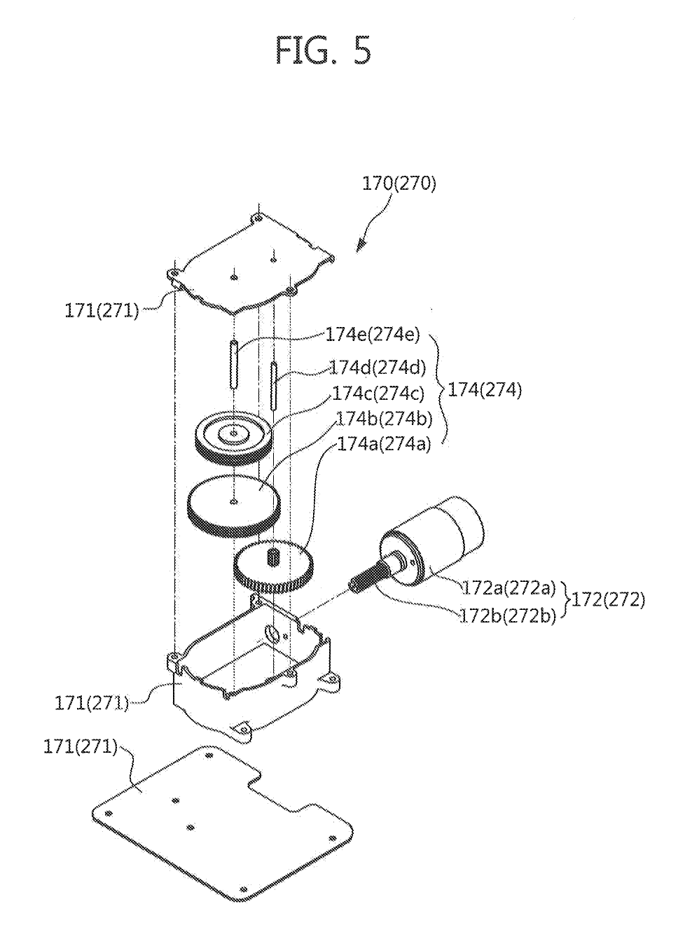

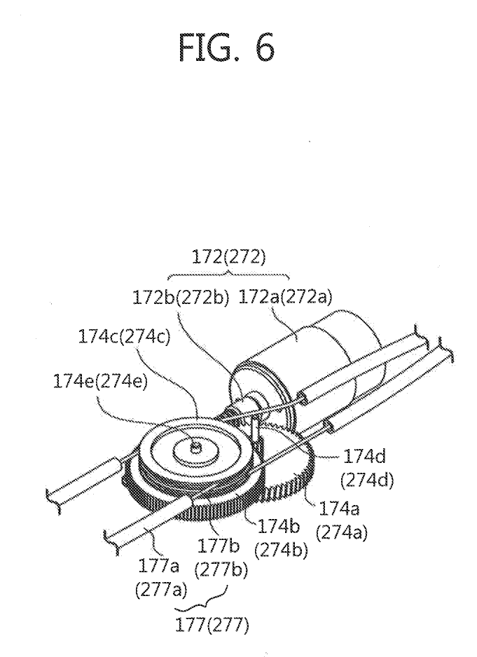

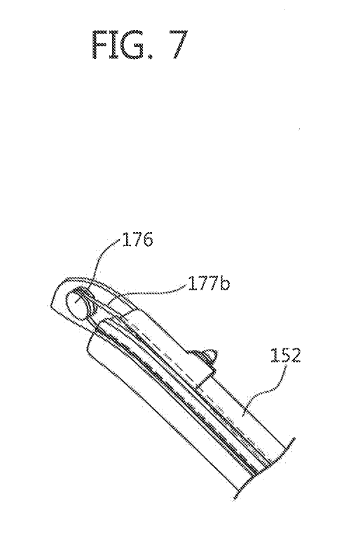

FIG. 5 is an exploded perspective view of a driving unit in association with the window blind assembly for a vehicle according to the first and second exemplary embodiments of the present invention. FIG. 6 is an enlarged perspective view of the driving unit in association with the window blind assembly for a vehicle according to the first and second exemplary embodiments of the present invention. FIG. 7 is a partial enlarged view of the guide rail in association with the window blind assembly for a vehicle according to the first exemplary embodiments of the present invention.

As shown in FIGS. 5 to 7, the driving unit 170 includes a casing 171, a motor 172, a gear assembly 174, a support wheel unit 176, a power transmission member 177, and a guide wheel unit 179.

The driving unit 170 provide driving force to the blind unit 140 so that the shade curtain supporter 144 can move up or down along the guide rail 150.

The casing 171 accommodates the gear assembly 174 therein. The motor 172 includes a motor body 172a and a motor shaft 172b.

The gear assembly 174 includes a first gear 714a, a second gear 174b, a wire driving wheel 174c, a first shaft 174d and a second shaft 174e.

The first gear 174a is provided in the form of a worm gear for changing a transfer direction of rotary force from the motor body 172a, and the motor shaft 172b is provided in the form of a worm shaft to mate with the first gear 174a. The first gear 174a mates with the second gear 174b by a spur gear structure, so that the first gear 174a and the second gear 174b can rotate in opposite directions to each other. The second gear 174b is selected to have a proper gear ratio so that rotation speed can be controlled. The wire driving wheel 174c is arranged on the top of the second gear 174b so as to rotate together with the second gear 174b. The wire driving wheel 174c and the second gear 174b may be provided as a single member. To transmit the rotary force of the wire driving wheel 174c to the power transmission member 177, a pair of wires 177b is coupled to the wire driving wheel 174c. Hence, the pair of wires are rotated in directions opposite to each other as the wire driving wheel 174c rotates. The wire driving wheel 174c is provided as a single, and grooves are formed on the outer circumference of the wire driving wheel 174c to respectively connect with the pair of wires.

The first gear 174a rotates with respect to the first shaft 174d, and the second gear 174b rotates with respect to the second shaft 174e.

Alternatively, the motor shaft 172b of the motor 172 may be directly connected to the wire driving wheel.

The power transmission member 177 includes a wire cover 177a, and a wire 177b retractably inserted in the wire cover 177a. The power transmission member 177 forms a pair to transmit the driving force to the pair of guide rails 150, respectively. The wire 177b is provided as a closed loop. The wire 177b has one side arc coupled to the wire driving wheel 174c, and the other side arc coupled to the support wheel unit 176 rotatably arranged in an upper end portion of the guide rail body 152.

One of the pair of power transmission members 177 (refer to the left power transmission member in FIG. 1) is coupled to the guide wheel unit 179 as being twisted by 180 degrees. Otherwise, the pair of connection units 144b may move in opposite directions to each other. That is, one of the pair of wires is twisted by 180 degrees and then connected to the guide wheel 179 in order to transmit the driving force in the same direction to the opposite end portions of the shade curtain supporter 144.

As shown in FIG. 7, the support wheel unit 176 may be rotatably formed in the end portion of the guide rail body 152. The support wheel unit 176 rotatably supports a part of the wire 177b having a closed-loop shape. That is, the wire 177b has one end portion connected to the gear assembly, and the other end portion rotatably supported by the support wheel unit 176.

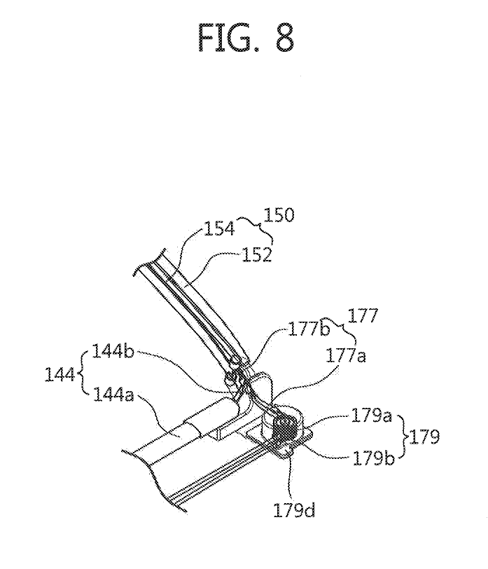

FIG. 8 is a partial perspective view of a guide wheel in association with the window blind assembly for a vehicle according to the first exemplary embodiments of the present invention.

As shown in FIG. 8, each of the pair of guide wheel units 179 includes a first guide wheel 179a, a second guide wheel 179b, a wheel casing 179c, and a wheel base 179d. The guide wheel unit 179 is positioned between the gear assembly 174 and the support wheel unit 176 so as to guide the wire 177b.

The first guide wheel 179a and the second guide wheel 179b are arranged in the wheel base 179d so that they can rotate independently of each other with respect to one shaft. As the wire 177b having the closed-loop shape is rotated, the first guide wheel 179a and the second guide wheel 179b are rotated in opposite directions to each other. That is, the first guide wheel 179a guides a first part of the wire 177b moving in a first direction, and the second guide wheel 179b guides a second part of the wire 177b moving in a direction opposite to the first direction.

The wheel casing 179c is arranged in the wheel base 179d so as to accommodate the first guide wheel 179a and the second guide wheel 179b therein. The wheel base 179d may be fastened to the frame bar 112 or the supporter 114.

The wheel casing 179c is formed with a plurality of through holes through which the wires 177b passes. With reference to FIGS. 6 and 8, when the wire driving wheel 174c rotates clockwise, the wheel casing 179c is formed with a first through hole through which a wire section making the first guide wheel 179a rotate counterclockwise enters the wheel casing 179c, and a second through hole through which it exits the wheel casing 179c. Also, when the wire driving wheel 174c rotates clockwise, the wheel casing 179c is formed with a third through hole through which a wire section of rotating the second guide wheel 179b clockwise enters the wheel casing 179c, and a fourth through hole through which it exits the wheel casing 179c. The wire cover 177a has an end portion fastened to the outside of the wheel casing 179c.

Thus, the driving force of the driving unit 170 is transmitted to the guide wheel unit 179, and then transmitted to the connection unit 144b, and its transmission direction is changed in the support wheel unit 176. The driving force of which the transmission direction is changed in the support wheel unit 176 is also transmitted to the guide wheel unit 179 and then transmitted to the driving unit 170.

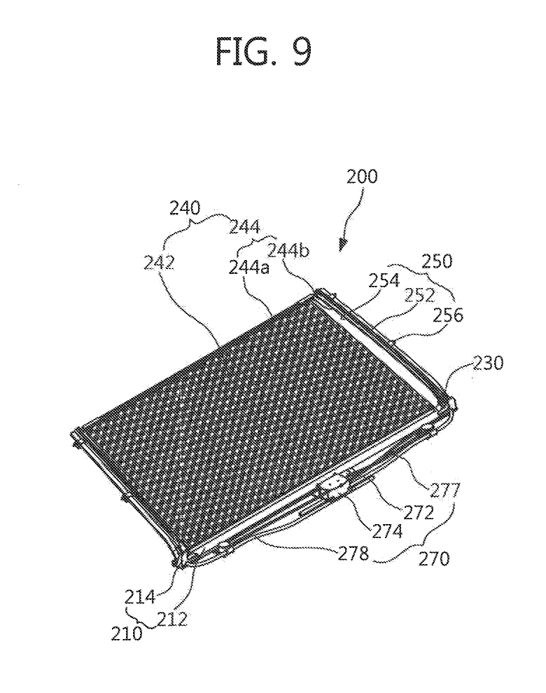

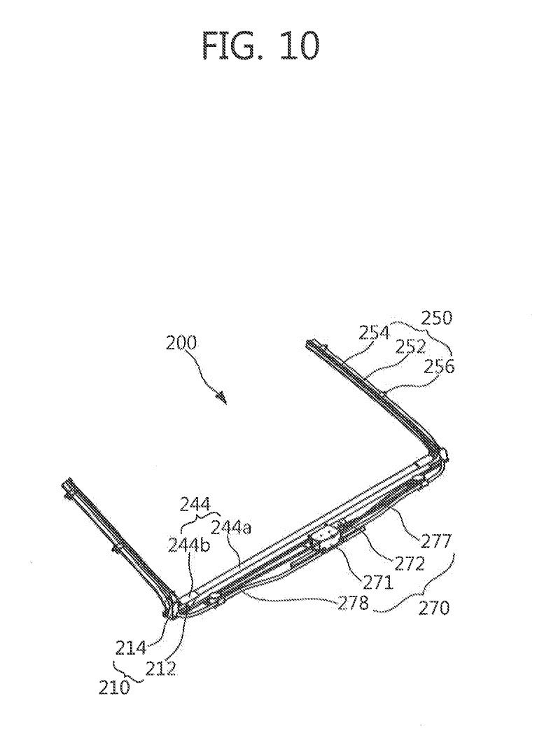

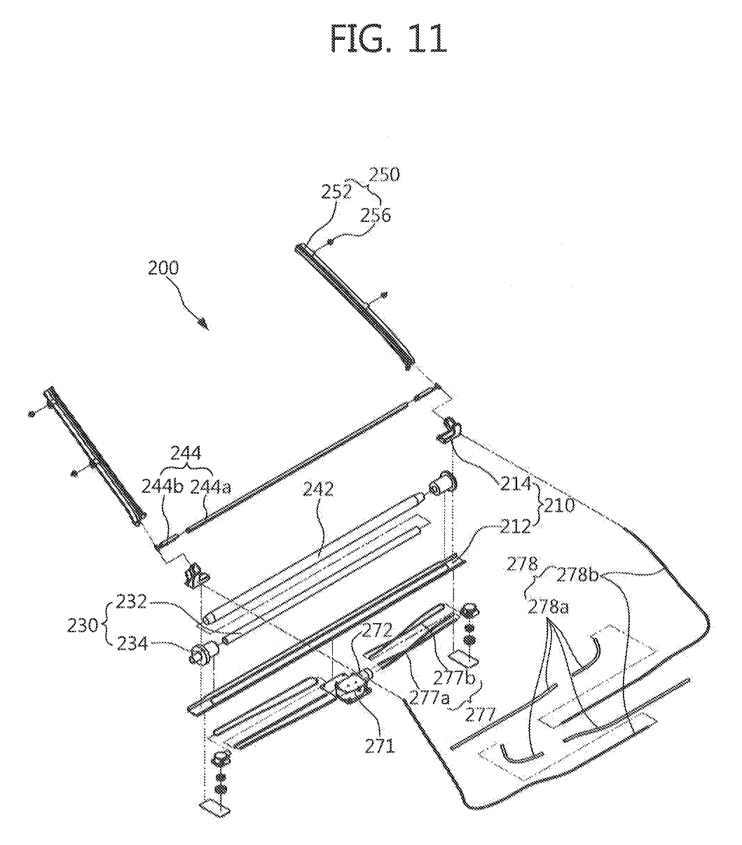

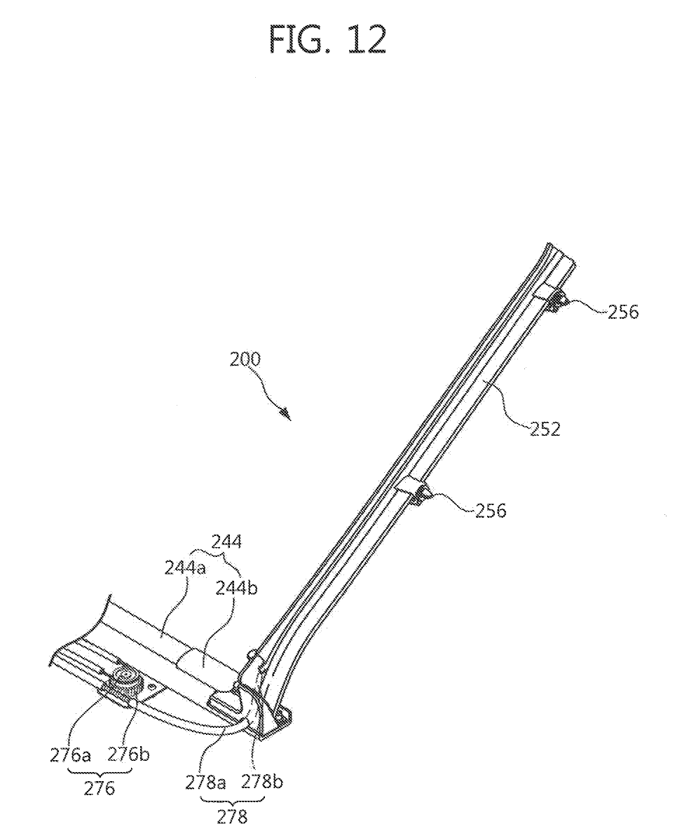

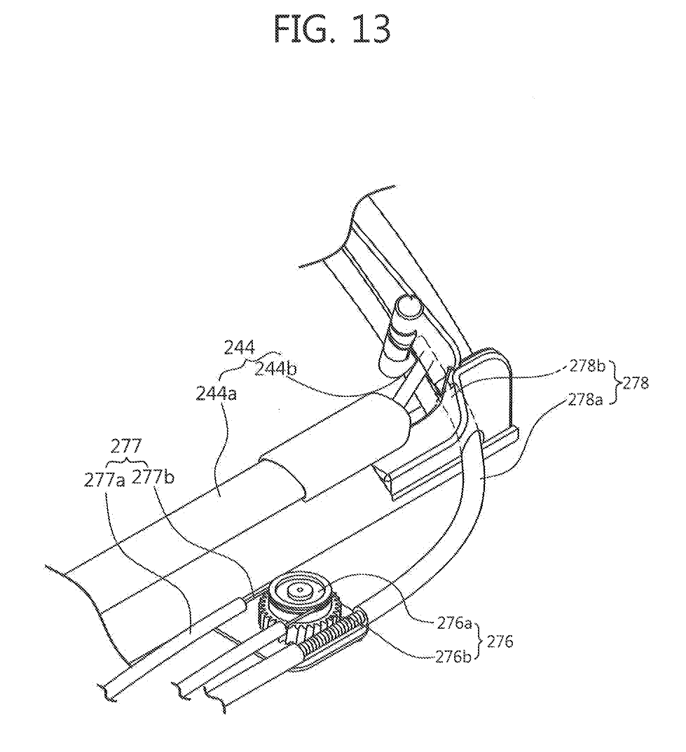

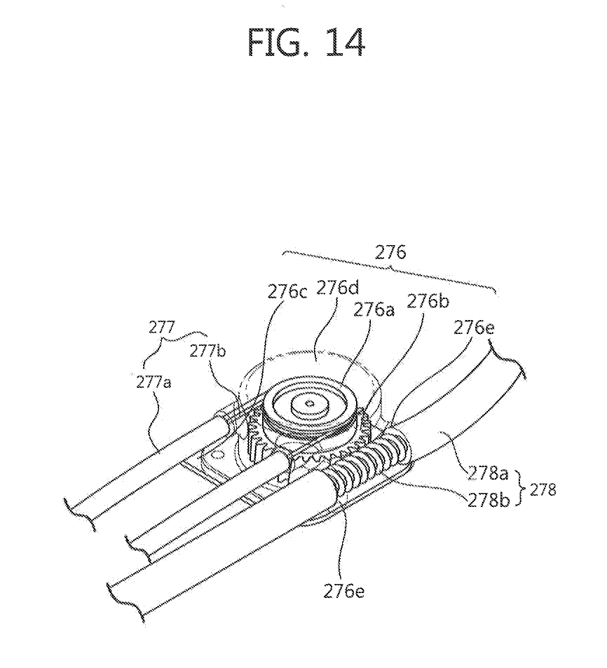

FIG. 9 is a perspective view showing an unrolled state of a shade curtain in association with a window blind assembly for a vehicle according to the second exemplary embodiment of the present invention. FIG. 10 is a perspective view showing a state that the shade curtain is rolled into a rotary shaft in association with the window blind assembly for a vehicle according to the second exemplary embodiment of the present invention. FIG. 11 is an exploded perspective view of the window blind assembly for a vehicle according to the second exemplary embodiment of the present invention. FIG. 12 is a partial perspective view of a guide rail and a support wheel unit in association with the window blind assembly for a vehicle according to the second exemplary embodiment of the present invention. FIG. 13 is an enlarged perspective view of the guide rail and the support wheel unit in association with the window blind assembly for a vehicle according to the second exemplary embodiment of the present invention. FIG. 14 is an enlarged perspective view of the support wheel unit in association with the window blind assembly for a vehicle according to the second exemplary embodiment of the present invention.

As shown in FIGS. 9 to 11, a widow blind assembly 200 for a vehicle according to the second exemplary embodiment of the present invention includes a main frame 210, a shaft unit 230, a blind unit 240, a guide rail 250 and a driving unit. With regard to elements similar to those described in the first exemplary embodiment will be omitted for convenience.

As shown in FIG. 11, the main frame 210 includes a frame bar 212 and a supporter 214. A shaft unit 230 includes a rotary shaft 232 and a rotary shaft supporter 234. The blind unit 240 includes a shade curtain 242 and a shade curtain supporter 244. The shade curtain supporter 244 includes a support body 244a and a connection unit 244b.

As shown in FIGS. 11 to 13, at least a part of the connection unit 244b may be accommodated in a guide groove 254 of the guide rail body 252. The connection unit 244b is connected to a second wire 278b of a second power transmission member 278 so that the support body 244a can move up and down along the guide groove 254. The guide rail 250 includes a guide rail body 252, a guide groove 254 and a guide rail supporter 256.

As shown in FIGS. 9 and 10, the driving unit 270 includes a casing 271, a motor 272, a gear assembly 274, a support wheel unit 276, a first power transmission member 277, and a second power transmission member 278.

As shown in FIGS. 5 and 6, the gear assembly 274 includes a first gear 274a, a second gear 274b, a wire driving wheel 274c, first shaft 274d and a second shaft 274e. The wire driving wheel 274c is coupled with a pair of first wires 277b so that the rotary force of the wire driving wheel 274c can be transmitted to the first power transmission member 277.

As shown in FIGS. 11 and 12, the first power transmission member 277 includes a first wire cover 277a, and a first wire 277b retractably inserted in the first wire cover 277a. The first wire 277b has one side arc coupled to the wire driving wheel 274c, and the other side arc coupled to a support wheel 276a of the support wheel unit 276.

As shown in FIGS. 11 to 13, the second power transmission member 278 includes a second wire cover 278a, and a second wire 278b retractably inserted in the second wire cover 278a. The second wire 278b is formed with a concavo-convex pattern on the surface thereof to mate with the support gear 276b so that the second wire 278b can move forward or backward as the support gear 276b rotates.

The second wire 278b has stiffness strong enough to free from buckling even when pushing the connection unit 244b upward along the guide groove 254.

One of the pair of first power transmission members 277 (refer to the left power transmission member in FIG. 9) is coupled to the support wheel unit 276 as being twisted by 180 degrees. Otherwise, the pair of connection units 244b may move in opposite directions to each other.

As shown in FIG. 14, the support wheel unit 276 includes a support wheel 276a, a support gear 276b, a support plate 276c, a first casing 276d, and a second casing 276e. For the convenience of description, the first casing 276d and the second casing 276e were omitted in FIGS. 12 and 13. For the convenience of description, the first casing 276d and the second casing 276e were illustrated as dotted lines in FIG. 14.

Referring to FIG. 14, the support plate 276c may be arranged in the frame bar 212. The support wheel 276a and the support gear 276b are rotatably arranged in the support plate 276c. The support wheel 276a and the support gear 276b are rotated together with respect to one shaft. The first wire 277b is wound around the support wheel 276a so that the rotary force of the wire driving wheel 274c can he transmitted to the support wheel 276a. the support gear 276b is arranged to contact the second wire 278b having the concavo-convex surface so that rotary motion of the support wheel 276a and the support gear 276b can be transformed into rectilinear motion of the second wire 278b. The first casing 276d arranged in the support plate 276c accommodates the support wheel 276a and the support gear 276b therein. With reference to FIG. 14, when the wire driving wheel 274c rotates clockwise, the first casing 276d is formed with a first through hole through which a section of the first wire 277b of rotating the support wheel 276a clockwise enters the first casing 276d, and a second through hole through which it exits the first casing 276d. The second wire 278b is retractably arranged in the second casing 276e. The first casing 276d and the second casing 276e may be formed as a single body. The first wire cover 277a has an end portion fastened to the outside of the first casing 276d.

Thus, the rotary motion of the driving unit 270 is transferred to the support wheel unit 276, and the support wheel unit 276 transforms the rotary motion into the rectilinear motion, thereby moving the second wire 278b forward or backward.

As described above, the present invention provides a window blind assembly for a vehicle in which vibration and noise are reduced and reliability of operation is enhanced.

Technical effects of the present invention are not limited to the foregoing technical effect, and other technical effects not mentioned above will be clearly understood by those skilled in the art from the following descriptions.

The exemplary embodiments should be considered in descriptive sense only and not for purposes of limitation. Therefore, the scope of the invention is defined not by the detailed description of the invention but by the appended claims, and it will be understood by a person having ordinary skill in the art that various changes in form and details may be made therein without departing from the spirit and scope of the invention as defined by the appended claims.

What is claimed is:

1. A window blind assembly for a vehicle, comprising:
a main frame;
a rotary shaft rotatably arranged in the main frame;
a pair of guide rails arranged in the main frame and formed with a guide groove;
a shade curtain supporter movably coupled to the pair of guide rails;
a shade curtain comprising one side end portion connected to the rotary shaft and rolled into the rotary shaft, and the other side end portion connected to the shade curtain supporter and unrolled as the shade curtain supporter becomes apart from the rotary shaft; and
a driving unit providing driving force to move the shade curtain supporter along the guide rail,
the driving unit comprising:
a motor;
a gear assembly connected to the motor; and
a first wire having a closed-loop shape and connected to the gear assembly so that driving force of the motor can be transferred to the shade curtain supporter.

2. The window blind assembly for a vehicle according to claim 1, wherein the first wire forms a pair to respectively transfer driving force to opposite end portions of the shade curtain supporter.

3. The window blind assembly for a vehicle according to claim 2, wherein the gear assembly comprises a wire driving wheel to transfer rotary force from the motor to the pair of first wires, and the pair of first wires is connected to the wire driving wheel so that the pair of first wires can rotate in opposite directions to each other.

4. The window blind assembly for a vehicle according to claim 3, wherein the wire driving wheel is provided as a single, and the wire driving wheel is formed with grooves on an outer circumference thereof for the pair of first wires to be respectively arranged on the wire driving wheel.

5. The window blind assembly for a vehicle according to claim 1, wherein the gear assembly comprises a first gear connected to a motor shaft of the motor, the motor shaft is provided as a worm shaft to change a rotary axis of rotary force from the motor, and the first gear is provided as a worm gear.

6. The window blind assembly for a vehicle according to claim 1, wherein
the driving unit further comprises a support wheel unit, and
the first wire comprises one end portion connected to the gear assembly, and the other end portion rotatably supported by the support wheel unit.

7. The window blind assembly for a vehicle according to claim 6, wherein
the shade curtain supporter comprises a support body connected to the one side end portion of the shade curtain, and a connection unit formed at opposite end portions of the support body, and
the connection unit is fastened to the first wire so that the support body can move as the first wire rotates.

8. The window blind assembly for a vehicle according to claim 7, wherein the support wheel unit is arranged in the guide rail so as to rotatably support one end portion of the first wire.

9. The window blind assembly for a vehicle according to claim 8, wherein the driving unit further comprises a guide wheel unit positioned between the gear assembly and the support wheel unit so as to guide the first wire.

10. The window blind assembly for a vehicle according to claim 9, wherein the guide wheel unit comprises
a wheel base; and
a first guide wheel and a second guide wheel arranged on the wheel base and rotatable with respect to one shaft,
the first and second guide wheels are rotatable independently of each other, and
the first guide wheel guides a first section of the first wire moving in a first direction, and the second guide wheel guides a second section of the first wire moving in a direction opposite to the first direction.

11. The window blind assembly for a vehicle according to claim 10, wherein the guide wheel unit further comprises a wheel casing coupling with the wheel base so as to accommodate the first and second guide wheels therein, and the wheel casing is formed with a plurality of through holes so that the first wire can pass through the guide wheel unit.

12. The window blind assembly for a vehicle according to claim 9, wherein the first wire forms a pair to respectively transfer driving force to opposite end portions of the shade curtain supporter, the gear assembly comprises a wire driving wheel to transfer rotary force from the motor to the pair of first wires, and the pair of first wires are connected to the wire driving wheel so that the pair of first wires can rotate in opposite directions to each other,
one of the pair of first wires being connected to the guide wheel unit as being twisted by 180 degrees so as to transfer driving force in one direction to opposite end portions of the shade curtain supporter.

13. The window blind assembly for a vehicle according to claim 6, wherein
the support wheel unit is arranged in the main frame, and
the driving unit further comprises second wire which has one side connected to the support wheel unit so as to transform rotary motion of the support wheel unit into rectilinear motion, and the other side connected to the shade curtain supporter so as to move the shade curtain supporter.

14. The window blind assembly for a vehicle according to claim 13, wherein
the shade curtain supporter comprises a support body connected to the one side end portion of the shade curtain, and a connection unit formed at opposite end portions of the support body, and
the connection unit is fastened to the second wire so that the support body can move as the second wire rectilinearly moves.

15. The window blind assembly for a vehicle according to claim 13, wherein
the support wheel unit comprises
a support plate connected to the main frame;
a support wheel connected to the first wire and arranged in the support plate so as to be rotated by the first wire; and
a support gear arranged in the support plate and rotatable together with the support wheel.

16. The window blind assembly for a vehicle according to claim 15, wherein the second wire comprises a concavo-convex surface to mate with the support gear so that the second wire can move forward or backward as the support gear rotates.

17. The window blind assembly for a vehicle according to claim 16, wherein the support wheel unit couples with the support plate so as to accommodate the support wheel and the support gear therein, and comprises a support casing through which the second wire passes, and the support casing comprises a plurality of through holes so as to pass the first wire therethrough.

18. The window blind assembly for a vehicle according to claim 15, wherein the first wire forms a pair to respectively transfer driving force to opposite end portions of the shade curtain supporter, the gear assembly comprises a wire driving wheel to transfer rotary force from the motor to the pair of first wires, and the pair of first wires are connected to the wire driving wheel so that the pair of first wires can rotate in opposite directions to each other,
one of the pair of first wires being connected to the support wheel unit as being twisted by 180 degrees so as to transfer driving force in one direction to opposite end portions of the shade curtain supporter.
